(19) United States
(12) Patent Application Publication
(10) Pub. No.: US 2007/0168990 A1
(43) Pub. Date: Jul. 19, 2007

(54) METHOD AND SYSTEM FOR BUILDING, PROCESSING, & MAINTAINING SCENARIOS IN EVENT-DRIVEN INFORMATION SYSTEMS

(75) Inventors: Melanie A. Alshab, Indianapolis, IN (US); Peter J. Bales, St. Peters, MO (US); Robert D. Covington, Evansville, IN (US); Jonathan D. Theophilus, Indianapolis, IN (US); Lisa M. Trotter, Fishers, IN (US)

Correspondence Address: BAKER & DANIELS LLP, 300 NORTH MERIDIAN STREET, SUITE 2700, INDIANAPOLIS, IN, 46204, US

(73) Assignee: RHYSOME, INC., Indianapolis, IN (US)

(21) Appl. No.: 11/532,450

(22) Filed: Sep. 15, 2006

Related U.S. Application Data
(60) Provisional application No. 60/718,147, filed on Sep. 16, 2005.

(51) Int. Cl. G06F 9/44

(52) U.S. Cl. 717/127

(57) ABSTRACT

The present invention allows Scenarios to be easily created and maintained via a graphical user interface and processed efficiently by re-using Actions and Action Chains and aggregating duplicated Actions and Action Chains. The method of building, maintaining, re-using, and aggregating Actions and Action Chains utilizes Event-Driven Information Systems and supports the three styles of event processing: simple event processing, event stream processing, and complex event processing.

This application claims the benefit of U.S. Provisional Patent Application Ser. No. 60/718,147 filed Sep. 16, 2005, the complete disclosure of which is hereby expressly incorporated by reference.

### BACKGROUND OF THE INVENTION

1. Field of the Invention

The invention relates to event-driven information systems.

2. Background of the Invention

Today's information society is founded upon gathering and sharing information. All organizations—commercial, government, and military—are dependent upon electronic information processing. This foundational backbone is the kind of distributed computing system based on computer networks that is traditionally called the “information technology layer” (or IT layer) of the organization. The use of these systems has expanded rapidly over the past ten years to meet the increasing demands of automation, electronic commerce, and the Internet explosion. Investment in technology has focused on making IT systems faster, capable of handling larger and larger amounts of information, and able to collaborate with one another. The world is now an open enterprise, where commerce and information move across the boundaries of organizations and nations.

Less investment has been devoted to develop technology that solves the increasing problem of understanding what is happening in IT systems. Whenever there is a crisis (e.g.: a denial-of-service attack or a system failure), initially no one understands what is occurring or how to fix it, and as a result, organizations scramble for weeks to determine what caused the crisis.

Event-driven information systems are computer systems that are engineered based on Event-Driven Architecture (EDA). An EDA defines a methodology for designing and implementing applications and systems in which events transmit between de-coupled software components and services. It is a software architecture that defines how systems can be engineered and designed to sense and respond to events. An event can be defined as “a significant change in state”. State changes for objects can create events. For example, when a car is purchased its state changes from un-owned to owned and possibly traded.

Event-driven means simply that whatever tools and applications are used to automate business and enterprise management processes, those tools and applications rely on receiving events to monitor the progress of a process and issuing events to initiate its next stages. This is becoming universal for all business processing. For example, simple document processing, such as moving purchase orders through a chain of activities or process steps—for example, authentication, inventory checking, payment, and delivery—is managed by workflow engines that rely on events from the process steps to drive the execution of the process. Typically, those events may come in the form of messages across the Internet from separate departments of the enterprise in different geographic locations. Another example is manufacturing processes, such as chip fabrication. These processes are controlled by complicated sequences of events flowing back and forth between the fabrication line (fabline) machines and process-controller engines that track the progress and test results of each cassette of wafers as they move along the line through a six-week manufacturing process.

In an EDA, when a notable thing happens inside and/or outside the business, that information disseminates immediately to all interested parties (human or automated). The interested parties evaluate the event, and optionally take action. The event-driven action may include the invocation of a service, the triggering of a business process, and/or further information publication/syndication. By its nature, an event-driven architecture is extremely de-coupled, and highly distributed. The creator (source) of the event only knows the event transpired. The creator has no knowledge of the event's subsequent processing, or the interested parties. The traceability of an event through a dynamic multipath event network can be difficult. Thus, EDAs are best used for asynchronous flows of work and information. There are three general styles of event processing: simple, stream, and complex. The three styles are often used together in a mature event-driven architecture.

In simple event processing, a notable event happens, initiating downstream action(s). Simple event processing is commonly used to drive the real-time flow of work—taking lag time and cost out of a business. For example, when an on-line order is placed by a customer to purchase a widget, the seller immediately commits inventory which shifts inventory from available to reserved. It then checks the remaining inventory against optimal inventory thresholds. If the inventory falls below the threshold, an event is generated. When the event is received and processed by a simple event processing engine, a re-order inventory process is initiated and the subscribers (the processes and people who need to know) are notified of the low inventory.

In event stream processing, both ordinary and notable events happen. Ordinary events are both screened for notability and streamed to information subscribers. Stream event processing is commonly used to drive the real-time flow of information in and around the enterprise—enabling in-time decision making. For example, in a trading platform, data streams provide information on the bid and ask of specific financial instruments. If a certain stock has a bid and an ask that matches a transaction of selling shares from the “asker” to the bidder can be concluded.

Complex Event Processing (CEP) evaluates a confluence of events and then takes action. The events (notable or ordinary) may cross event types and occur over a long period of time. The event correlation may be causal, temporal, or spatial. CEP requires the employment of sophisticated event interpreters, event-pattern definition and matching, and correlation techniques. CEP is commonly used to detect and respond to business anomalies, threats, and opportunities.

An example of a complex event is the completion of a financial transaction involving a bundle of financial contracts. Several merchant banks and brokerage houses may participate in the transaction. They use a global trading network. The event itself, the completion of the transaction, might be the result of hundreds of electronic messages and entries into several different databases around the world over a span of two or three days. These events don't necessarily happen in a nice linear order, one after the other. Some of them might happen simultaneously and independently of others, mixed in with events from other transactions. CEP can be applied to the trading network, beyond just a single platform, to recognize when that complex event happens or if it is getting off track and may not happen, and why.

An event is a notable thing that happens inside and/or outside of business. An event (business or system) may signify a problem or impending problem, an opportunity, a threshold, or a deviation. Event-driven information systems make use of techniques and tools used to help enterprises understand and control event-driven information systems. Any kind of information system, from the Internet to a cell phone, is driven by events.

For example, a car on the showroom floor of a car dealership is there only because a number of other events took place—events in the inventory control systems of the dealership and the manufacturer, shipping events, custom events at the port of entry, and so on. When a buyer sees exactly what they want in the showroom, they don't ask how or why it got there. But if they don't see the model, make, or color they want and ask why not, they will get an explanation about allocation quotas, backlogs at the factory, or some other factors that affect events in the causal history leading up to the event they wanted.

Information systems are all driven by events. To be sure, each system, or application running on top of a system, depends upon different kinds of events. Network events are different from database events, which are different from financial trading events. An EDA allows different kinds of events to be related and provides techniques for defining and utilizing relationships between events. These techniques can be applied to any type of event that happens in a computer application or a network or an information system. A user can define their own events as patterns of the events in the computer system and can have responses initiated including sending alerts and/or notifications when events happen.

Events of interest can be low-level network monitoring alerts or high-level enterprise management intelligence, depending upon the role and viewpoint of individual users. Different kinds of events can be specified and monitored simultaneously. Further, the specification of the events of interest, how they should be viewed and acted upon, can be changed dynamically, while the system is running.

A distributed information system consisting of a widely dispersed set of several thousands or hundreds of thousands of application programs (or component objects, as they are often called) communicating with one another by means of messages transmitted over an IT layer containing various kinds of media have come to be collectively called “enterprise systems”. They all have a common basic problem. Their activities are driven by the events flowing through their IT layers. And they produce a significant number of events per hour or day. Traditionally there is no technology that enables users to view events and activities that are going on inside these systems in ways that can be easily understood.

### SUMMARY OF THE INVENTION

The invention enables: a) Actions to be re-used through defined Scenarios, b) Actions and Action Chains to be aggregated across Scenarios, and c) processing to be minimized across all defined Scenarios. Users need to be able to answer questions about events that are not simply low-level network activities, but are high-level activities related to the purpose(s) of the systems-so called business-level, or strategic-level, events.

A lot of the information in IT systems is never recognized. Messages—or events—pass silently back and forth across information systems as unrelated pieces of communication. However, they are a source of great power, for when they are aggregated together, and correlated, and their relationships understood, they yield a wealth of information.

These questions are about complex events, which are built out of lots of simpler events. Answering them means that the user needs to be able to view their enterprise systems in terms of how they are used—not in terms of how they are built, which is the state of the art in enterprise monitoring technology today.

To keep the event-driven global information society on track, a number of related problems must be resolved: a) monitor events at every level in IT systems-worldwide and in real-time, b) detect complex patterns of events, consisting of events that are widely distributed in time and location of occurrence, c) trace causal relationships between events in real-time, both horizontally within a level of system activity and vertically between high and low levels of system activity, d) take appropriate action when patterns of events of interest or concern are detected, e) modify monitoring and action strategies in real-time, dynamically, and f) design systems to incorporate autonomous processes for applying level wise event monitoring and viewing and for taking appropriate actions.

This event processing technology is applicable to every level of system operations in all IT layers. Such a technology is a key foundation to managing the electronic enterprise and is critical to developing capabilities to defend IT systems.

As enterprises adopt the electronic collaboration model, their boundaries become blurred. Events are being created internally, within the enterprise, and externally, outside the enterprise. These events flow in both directions across the IT layer boundaries, its network gateways and firewalls. Events are flowing between the enterprise and its trading partners, the electronic market hubs in which it is participating, and its outsourcing activities with its ASPs, as well as between its own operations. The enterprise is becoming open to permit the event traffic it needs in order to pursue its collaborations. This kind of openness requires sophisticated technology, including new kinds of authentication and real-time policy monitoring, which defend the enterprise without obstructing its business activities.

Today's reality is that the enterprise is operating in a complex environment of events happening on a global scale. These are high-level business, logistics, and application-to-application events. They form the global event cloud in which the open enterprise is operating. The scope of the global event cloud in which each enterprise must interact is continually increasing. Today, thousands of business-level events per second are being communicated across the IT layers of some enterprises. These numbers will increase with activity in the global eMarketplace.

In one form, the invention involves a server in a computer network which enables event-driven applications based on communications in the computer network. The server has monitor software in communication with the computer network. There are also a plurality of action chains, each action chain including at least one action software, each action software including a program module having at least one procedure and at least one parameter set for execution, each action software capable of returning a state, each said action software capable of activating an event-driven application according to the parameter. Dispatcher software may activate at least one of the action chains. A Domain Controller associated with the scenario manager organizes the action chains so that duplicative action software referenced by more than one of the action chains is eliminated. The Domain Controller also makes new action software available to the Dispatcher.

Further aspects of this form of the invention include monitor software that is further capable of determining a change of state in an element, and further capable of transmitting a notification to the dispatcher software including the change of state information. A repository stories a plurality of objects, each of the objects including a program module which is capable of being paired with a procedure and parameter. The repository may be included in a domain controller. The scenario manager is further capable of creating an action chain which includes specification of a prior action, an action result, and a subsequent action. The dispatcher activates a corresponding action chain in response to the execution of an event-driven application. The scenario manageer is capable of creating scenarios. The scenario manager software further includes a graphic user interface enabling a user to create a scenario. The scenario manager is capable of using one action software in a plurality of action chains.

Another aspect of the invention involves server in a computer network which enables event-driven applications based on communications in the computer network. The server has monitor software in communication with the computer network, action software including a program module having at least one procedure and at least one parameter set for execution which is capable of returning a state and activating an event-driven application according to the parameter. The dispatcher software activates action software. The scenario manager allows a user to define a new action software and make it available to the dispatcher.

Further aspects of this embodiment of the server invlove the monitor software being capable of determining a change of state in an element, and further capable of transmitting a notification to the dispatcher including the change of state information. The server also may have a repository capable of storing a plurality of objects, each of the objects including a program module and capable of being paired with at least one procedure and at least one parameter to create an action software. The repository may be included in a domain controller. The scenario manager is further capable of creating an action chain, each action chain including specification of a prior action, an action result, and a subsequent action. The dispatcher is adapted to activate action chains. The server may further include a repository capable of storing a plurality of action chains, with the dispatcher adapted to activate a corresponding action chain in response to the execution of an event-driven application. The scenario management software is capable of creating scenarios. The scenario management software further includes a graphic user interface enabling a user to create a scenario based on graphic representations of action software. The scenario management software is capable of using one action software in a plurality of action chains.

Another aspect of the invention involves a method of activating event-driven applications in a computer network having a server. One step of the method involves monitoring activities on the computer network. A repository is provided with a plurality of action chains, each action chain including at least one action software. Each action software includes a program module having at least one procedure and at least one parameter set for execution, each action software capable of returning a state, and each action software capable of activating an event-driven application according to the parameter. One of the action chains is activated based on activities monitored, and the plurality of action chains are organized so that duplicative action software referenced by more than one of said action chains are removed from the repository.

The further aspects of this method of the invention involve determining a change of state in an element, and further includes the step of transmitting a notification including the change of state information. The repository stores a plurality of objects, each of the objects including a program module and capable of being paired with at least one procedure and at least one parameter to create an action software. The repository includes a domain controller. The method may also include creating an action chain which has specification of a prior action, an action result, and a subsequent action. The dispatcher is adapted to activate the action chain. The step of creating scenarios, wherein each scenario includes property information and an action chain. The step of creating scenarios includes use of a graphic user interface enabling a user to create a scenario based on graphic representations.

Another embodiment of the method of executing a computer program in an event-driven application included a) providing an Object which represents a program module that contains procedures needed for performing a discrete function and returning a State during execution, b) providing an Action which is an instantiation of an Object in a running event-driven application with specific Parameters set for execution, c) providing an Action Chain which dictates the execution of Actions based on the State returned by the results of the previous Actions, d) activating a Dispatcher which executes an event-driven application by executing Actions based on one or more Action Chains.

Further aspects of this embodiment of the method of the present invention involves having an Object as a sensor which monitors an Element for a change in State upon which the Dispatcher is activated. The program code for an Object is stored in a central repository and downloaded by a Dispatcher when the event-driven application is executed. The central repository is a Domain Controller. The Action Chain is stored in a central repository and downloaded by a Dispatcher when an event-driven application is executed. The central repository for an Action Chain is an Enterprise Action Repository. The Action Chains are grouped into Scenarios. The graphical user interface is used to create and edit Scenarios. The Actions may be re-used in multiple Action Chains. The Dispatcher, prior to executing Action Chains, removes duplicate Actions by: a) identifying duplicated Actions with identical Parameters, b) updating an Action Chain to utilize the first occurrence of an Action in a set of Duplicate Actions, and c) removing all but the first duplicate Action.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIGS. 1A through 1C are schematic and flow chart diagrams that depict how a Scenario Management System functions as part of event-driven information systems. FIGS. 2A through 2B are schematic and flow chart diagrams that depict examples of the described invention in an effort to provide additional clarity.

Corresponding reference characters indicate corresponding parts. Although the drawings represent embodiments of the present invention, the drawings are not necessarily to scale and certain features may be exaggerated in order to better illustrate and explain the present invention. The exemplification set out herein illustrates embodiments of the invention, in several forms, and such exemplifications are not to be construed as limiting the scope of the invention in any manner.

### DETAILED DESCRIPTION OF EMBODIMENTS OF THE PRESENT INVENTION

The described invention relates to using a Scenario Management System and how it provides an efficient and highly optimized way of building, processing, and maintaining Scenarios in event-driven information systems. To facilitate a better understanding of how the invention works with the overall system architecture of which it is a part, the following definitions are provided for clarity.

An Action is an instantiation of an Object as predefined in an Object Library and is a component of a Scenario. Once an Action is created (instantiated), its' parameters are saved in an Enterprise Action Repository (EAR).

An Action Chain is the combination of a previous Action, an Action State, and a next Action. Action Chains also contain Action and Scenario specific information (e.g.: Action ID, Scenario ID, etc.).

An Action State is a pre-defined result of an Action. Examples of Action States include UP and DOWN for an Action that monitors a device (e.g.: computer, printer, etc.), TRUE and FALSE are results for an Action that monitors a database for changes, etc.

An Action Type is a categorization of an Action. Examples include: Activator Action, Identifier Action, Control Action, Response Action, etc.

A Dispatcher is a program that aggregates and processes execution eligible Actions and execution eligible Action Chains contained within Scenarios.

A Domain Controller provides centralized management of the configuration and execution of Scenarios.

Duplicate Actions are Actions with identical Parameters, but may have different Properties. All duplicate Actions are placed into a Duplicate Action Group.

Duplicate Action Groups are groups of Actions that all have identical Parameters, but may have different Properties.

An Enterprise Action Repository is a collection of all Actions, Action States, Action Chains, Object definitions, and Scenario definitions in a Scenario Management System. This repository allows Actions to be re-used among multiple Scenarios. Multiple Scenarios can share an instance of a specific Action in an Enterprise Action Repository.

An Element is anything that can be monitored by a Sensor in order to detect and capture state changes. Some examples include: computer, printer, file, database, operating system, routing table, web site, email, log, network, instant message, message queue, directory, click stream, RSS feed, video stream, temperature probe, etc.

An Event Node is notified by a Sensor when a change in State occurs to or in a monitored Element and contains a Dispatcher.

An Event Space is a user interface of a Scenario Manager that allows a user to drag and drop graphical representations of Actions and Action States to build and maintain Scenarios.

An Object is a self-contained program module that contains data as well as procedures needed to make data useful (called a Method). Objects are stored in an Object Library. Each Object defines a set of properties and default parameters which are components of information required to process an Object. When an Object is instantiated for use in the system, it is known as an Action.

An Object Library contains Objects that are instantiated as Actions.

An Object Type is a categorization of an Object. Examples include: Activator Object, Identifier Object, Control Object, Response Object, etc.

A Parameter is any value that is required by an Object or an Action to be executed.

A Property is any value that describes an Object or an Action, but is not required for an Object or Action to be executed.

A Scenario is a visual representation of an Event that contains one or more Action Chains.

The Scenario Manager is a user interface that allows Scenarios to be created and managed.

A Sensor is a software routine that monitors an Element and detects when a change in State occurs.

A Server is a computer system that operates continuously on a network and waits for requests for services from other computers on the network. Although typically a single computer operating as the hub of a network system with the network software installed and running on that hub computer, a server may be a computer, router, or other device capable of transmitting information on the network and executing actions based on information received over the network. A server may be implemented as one or more computers, routers, or other computing machinery and/or software in a single location or virtually.

State is a status of a monitored Element. When there is a change in State, corresponding Actions are notified and the resulting information is used to determine next Action(s) to be executed in a Scenario.

The present invention involves how a Scenario Management System is efficiently utilized as part of event-drive information systems.

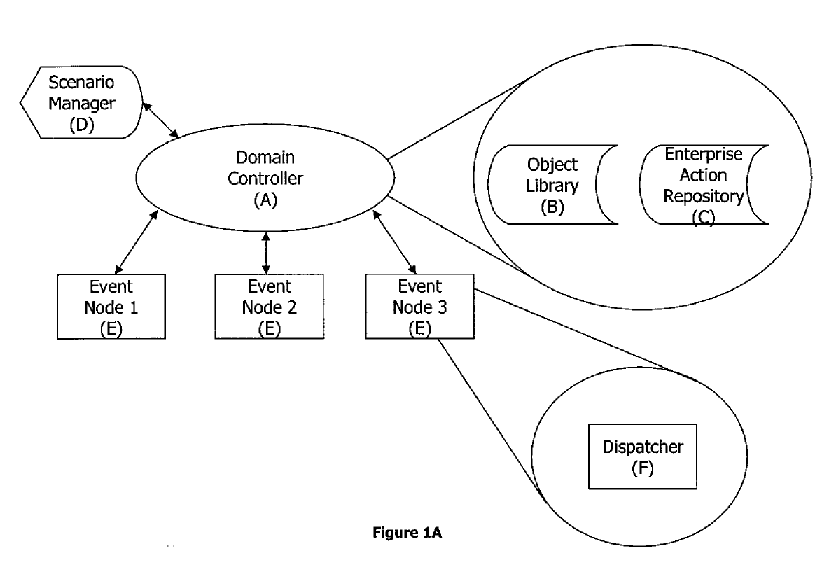

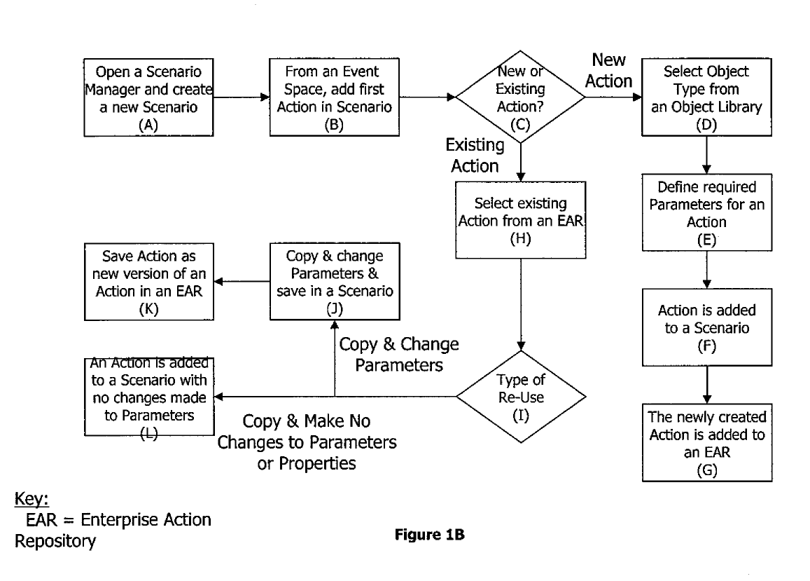

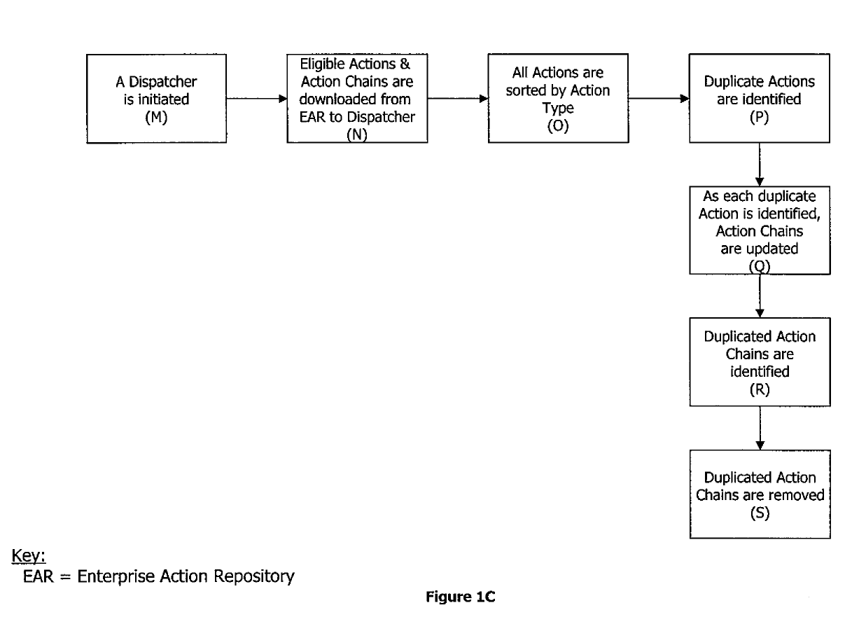

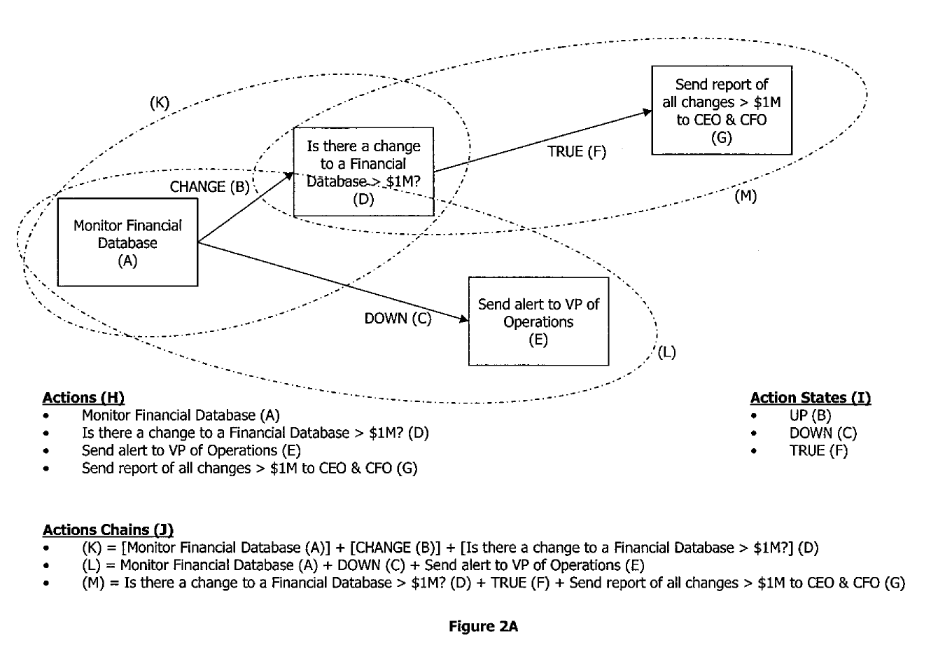

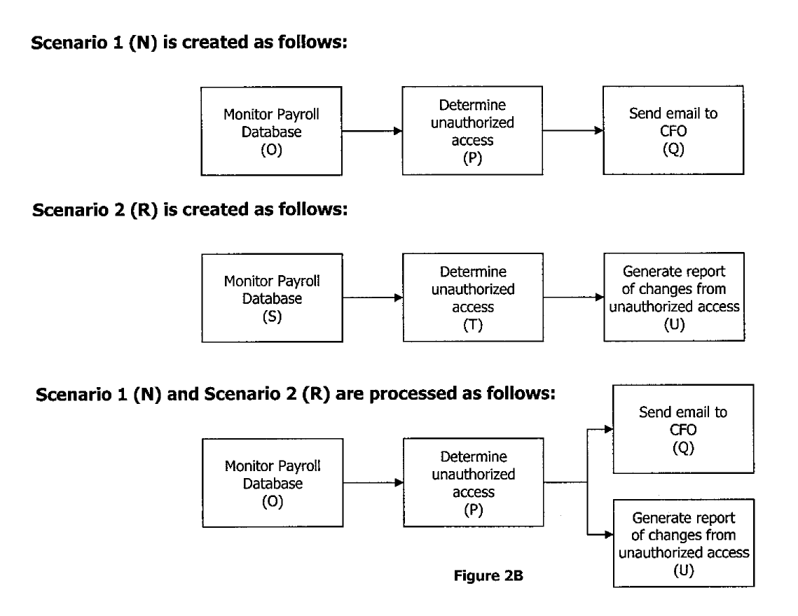

FIG. 1A depicts how Scenarios are created and processed by a Scenario Management system. In a Scenario Management System, Domain Controller (A) provides centralized management of the configuration and execution of Scenarios, for example by having action management software for organizing, editing and storing Actions, Action Chains, and Scenarios. Domain Controller (A) houses Object Library (B) and Enterprise Action Repository (C), for example by storing one or more actions, action chains, and scenarios. Scenario Manager (D) interfaces to Domain Controller (A). When Scenarios are configured, with the information needed for configuration and where the configurations are stored when completed, they are stored in an Enterprise Action Repository (C) which is located in Domain Controller (A). Event Nodes (E), for example software that monitors communications over the computer network, house Dispatcher (F), for example that activates Actions or Action Chains based on a notification of a change in State and/or occurrence of a specific Action. Event Nodes (E) are notified when a change in State is detected by a Sensor in Event Node (E). Dispatcher (F) aggregates and processes all execution eligible Actions and Action Chains.

FIG. 1B depicts how Scenarios are created and how Actions can be re-used among Scenarios. To create a Scenario, the user opens Scenario Manager (step A). Once the Property information is entered about a Scenario, the user is presented with a canvas, known as the Event Space, on which they can drag and drop graphical representations of Actions that comprise a Scenario. From an Event Space, a user selects to add first Action (step B) by deciding if they want to add a new Action (one that does not already exist in an Enterprise Action Repository) or re-use existing Action (one that does exist in an Enterprise Action Repository) (step C).

If a user decides to add a new Action (one that does not already exist in the Enterprise Action Repository), the user selects an Object by Object Type from an Object Library (step D). Once the user defines Object Properties, and Parameters for an Action are completed in (step E), an Action is added to a Scenario (step F). The newly created Action is added to Enterprise Action Repository (step G).

If a user decides to use an existing Action (already exists in an Enterprise Action Repository), an Action is selected from an Enterprise Action Repository (step H). Once a user has selected which Action is needed from an Enterprise Action Repository, it must be decided how an Action will be re-used. The options include: 1) copy an Action and change its Parameters or Properties (step J), or 2) copy an Action and make no changes to Parameters or Properties (step L).

If a user decides to copy an Action and make changes to its Parameters, an Action is placed on an Event Space using a drag and drop feature and Parameters or Properties are updated by a user (step J). Once changes to an Action's Parameters or Properties are saved, a new Action is saved in an Enterprise Action Repository (step K).

If a user decides to copy an Action and make no changes to Parameters or Properties, an Action is placed on an Event Space using a drag and drop feature and it is added to a Scenario (step L).

FIG. 1C depicts how Actions and Action Chains are aggregated by a Scenario Management system. A Dispatcher is initiated (step M). Once a Dispatcher is initiated, all execution eligible Actions and all execution eligible Action Chains are downloaded from an Enterprise Action Repository (step N). All Actions are sorted by Action Type (step 0) and Parameters of each Action are evaluated to identify Duplicate Actions (step P). As each Duplicate Action is identified, it is placed in a Duplicate Action Group and an Action Chain that contains a Duplicate Action is updated with the first occurrence in a Duplicate Action Group (step Q). Once all Duplicate Actions are identified and corresponding Action Chains are updated, all Action Chains are evaluated to identify identical Action Chains (step R). Once all identical Action Chains are identified, all but the first duplication are removed from processing (step S).

To provide more clarity to the invention disclosed, FIGS. 2A through 2B outline detailed examples as support to the previous invention descriptions.

FIG. 2A depicts Actions, Action States, and Action Chains that are the result of a specific Scenario. The Scenario is composed of the following Actions (H): “Monitor Financial Database” (action A), “Is there a change to the Financial Database>$1M?” (action D), “Send alert to VP of Operations” (action E), and “Send report of all changes>$1M to CEO & CFO” (action G). A Scenario is composed of Action States (I): “CHANGE” (state B), “DOWN” (state C), and “TRUE” (state F). Based on Actions (H) and Action States (I) in a Scenario, Action Chains are derived and placed in an Enterprise Action Repository when a Scenario is saved: (chain K) “Monitor Financial Database” (action A) and “CHANGE” (state B) and “Is there a change to the Financial Database>$1M?” (action D), (chain L) “Monitor Financial Database” (action A) and “DOWN” (state C) and “Send alert to VP of Operations” (action E), and (chain M) “Is there a change to the Financial Database>$1M?” (action D) and “TRUE” (state F) and “Send Report of all changes>$1M to CEO & CFO” (action G).

FIG. 2B depicts how Scenarios are aggregated to provide additional flexibility and scalability. Scenario 1 (N) is comprised of Actions: “Monitor Payroll Database” (action O), “Determine unauthorized access” (action P), and “Send email to CFO” (action Q). Scenario 2 (R) is comprised of Actions: “Monitor Payroll Database” (action S), “Determine unauthorized access” (action T), and “Generate report of changes from unauthorized access” (action U). Once all Actions and Action Chains are aggregated by a Dispatcher, then Actions would be processed: “Monitor Payroll Database” (action O), “Determine unauthorized access” (action P), “Send email to CFO” (action Q), and “Generate report of changes from unauthorized access” (action U).

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

We claim:

1. A server in a computer network, the server enabling event-driven applications based on communications in the computer network, the server comprising:
monitor software adapted to be in communication with the computer network and receive messages from the computer network;
a plurality of action chains, each said action chain including at least one action software, each said action software including a program module having at least one procedure and at least one parameter set for execution, each said action software capable of returning a state, each said action software capable of activating an event-driven application according to the parameter;
dispatcher software in communication with said monitor software and said plurality of action chains, said dispatcher software capable of activating at least one of said plurality of action chains; and
domain control software in communication with said plurality of action chains and said dispatcher, said domain control software capable of organizing said action chains so that duplicative ones of said action software referenced by more than one of said action chains, and said domain control software making said new one of said at least one action software available to said dispatcher.

2. The server of claim 1 wherein said monitor software is further capable of determining a change of state in an element, and further capable of transmitting a notification to said dispatcher including the change of state information.

3. The server of claim 1 further comprising a repository capable of storing a plurality of objects, each of said objects including a program module and capable of being paired with at least one procedure and at least one parameter.

4. The server of claim 13 wherein said domain control software includes said repository.

5. The server of claim 1 wherein said domain control software is further capable of creating an action chain, said action chain including specification of a prior action, an action result, and a subsequent action.

6. The server of claim 5 further comprising a repository capable of storing a plurality of action chains, said dispatcher adapted to activate a corresponding action chain in response to the execution of an event-driven application.

7. The server of claim 1 wherein said domain control software is capable of creating scenarios.

8. The server of claim 7 wherein said domain control software further includes a graphic user interface enabling a user to create a scenario.

9. The server of claim 5 wherein said domain control software is capable of using one of said at least one action software in a plurality of action chains.

10. A server in a computer network, the server enabling event-driven applications based on communications in the computer network, the server comprising:
monitor software adapted to be in communication with the computer network and receive messages from the computer network;
at least one action software, each said action software including a program module having at least one procedure and at least one parameter set for execution, each said action software capable of returning a state; each said action software capable of activating an event-driven application according to the parameter;
dispatcher software in communication with said monitor software and said at least one action software, said dispatcher software capable of activating said at least one action software; and
scenario manager software in communication with said at least one action software and said dispatcher, said scenario manager software capable of allowing a user to define a new one of said at least one action software and making said new one of said at least one action software available to said dispatcher.

11. The server of claim 10 wherein said monitor software is further capable of determining a change of state in an element, and further capable of transmitting a notification to said dispatcher including the change of state information.

12. The server of claim 10 further comprising a repository capable of storing a plurality of objects, each of said objects including a program module and capable of being paired with at least one procedure and at least one parameter to create an action software.

13. The server of claim 12 wherein said repository is included in a domain controller.

14. The server of claim 10 wherein said scenario manager software is further capable of creating an action chain, said action chain including specification of a prior action, an action result, and a subsequent action, and said dispatcher is adapted to activate said action chain.

15. The server of claim 14 further comprising a repository capable of storing a plurality of action chains, said dispatcher adapted to activate a corresponding action chain in response to the execution of an event-driven application.

16. The server of claim 10 wherein said scenario manager software is capable of creating scenarios.

17. The server of claim 16 wherein said scenario manager software further includes a graphic user interface enabling a user to create a scenario based on graphic representations of said action software.

18. The server of claim 14 wherein said scenario manager software is capable of using one of said at least one action software in a plurality of action chains.

19. A method of activating event-driven applications in a computer network having a server, the method comprising the steps of:
monitoring activities on the computer network;
providing a repository with a plurality of action chains, each said action chain including at least one action software, each said action software including a program module having at least one procedure and at least one parameter set for execution, each said action software capable of returning a state, each said action software capable of activating an event-driven application according to the parameter;
activating at least one of said plurality of action chains based on activities monitored; and
managing said plurality of action chains so that duplicative ones of said action software referenced by more than one of said action chains are removed from the repository.

20. The method of claim 19 wherein said monitoring step further includes the step of determining a change of state in an element, and further includes the step of transmitting a notification including the change of state information.

22. The method of claim 19 wherein the repository stores a plurality of objects, each of said objects including a program module and capable of being paired with at least one procedure and at least one parameter to create an action software.

23. The server of claim 22 wherein the repository is included in a domain controller.

24. The server of claim 19 further including the step of creating an action chain, said action chain including specification of a prior action, an action result, and a subsequent action, and said dispatcher is adapted to activate said action chain.

25. The server of claim 19 further comprising the step of creating scenarios, wherein each said scenario includes property information and an action chain.

26. The server of claim 25 wherein the step of creating scenarios includes use of a graphic user interface enabling a user to create a scenario based on graphic representations.

27. A method of executing a computer program in an event-driven application comprising of:
a) providing an Object which represents a program module that contains procedures needed for performing a discrete function and returning a State during execution,
b) providing an Action which is an instantiation of an Object in a running event-driven application with specific Parameters set for execution,
c) providing an Action Chain which dictates the execution of Actions based on the State returned by the results of the previous Actions,
d) activating a Dispatcher which executes an event-driven application by executing Actions based on one or more Action Chains.

28. The method of claim 27 wherein at least one Object is a sensor Object which monitors an Element for a change in State upon which to activate the Dispatcher.

29. The method of claim 27 wherein program code for an Object is stored in a central repository and downloaded by a Dispatcher when the event-driven application is executed.

30. The method of claim 29 wherein the central repository is a Domain Controller.

31. The method of claim 27 wherein the Action Chain is stored in a central repository and downloaded by a Dispatcher when an event-driven application is executed.

32. The method of claim 31 wherein the central repository for an Action Chain is an Enterprise Action Repository.

33. The method of claim 27 wherein Action Chains are grouped into Scenarios.

34. The method of claim 33 wherein a graphical user interface is used to create and edit Scenarios.

35. The method of claim 27 wherein Actions may be re-used in multiple Action Chains.

36. The method of claim 35 wherein a Dispatcher prior to executing Action Chains removes duplicate Actions by: a) identifying duplicated Actions with identical Parameters, b) updating an Action Chain to utilize the first occurrence of an Action in a set of Duplicate Actions, and c) removing all but the first duplicate Action.
